(19) United States
(12) Patent Application Publication
(10) Pub. No.: US 2025/0348691 A1
(43) Pub. Date: Nov. 13, 2025

(54) Length-Constrained Machine Translation Model

(71) Applicant: Google LLC, Mountain View, CA (US)

(72) Inventors: Haijie Hong, Shanghai (CN); Lu Sun, Shanghai (CN)

(21) Appl. No.: 18/563,235

(22) PCT Filed: Jan. 31, 2023
(86) PCT No.: PCT/CN2023/074019

§ 371 Date: Nov. 21, 2023

(51) Int. Cl. G06F 40/58; G06F 40/284; G06F 40/51

(52) U.S. Cl. CPC G06F 40/58; G06F 40/284; G06F 40/51

(57) ABSTRACT

Aspects of the disclosure are directed to controlling machine translation length based on length tokens. The length tokens are included in the machine translation source text and target text during training and also included in the machine translation source text during inference. An output is generated from a machine learning model constrained by length if the output from a machine learning model unconstrained by length outputs a translation exceeding a length limit.

### BACKGROUND

Machine translation corresponds to using software to translate text or speech from one language to another. Controlling the length of a machine translation output can be desired in some scenarios, such as in ads, user interfaces, or dubbing. Length normalization, verbosity tokens, and positional encoding have been utilized to control machine translation output length. However, with length normalization, matching character number, display width, and/or spoken duration can be difficult. Further, length normalization can have a minimal effect on length output when implementing a greedy beam search. With verbosity tokens, translation length cannot be controlled accurately due to the categorical nature of the tokens, e.g., short, normal, long. With positional encoding, only the token number can be controlled though it may be desired to control the character number or display width. A character-level vocabulary can be implemented, but this would increase latency significantly. Further, model output with positional encoding results in translations with the exact length constraint as opposed to outputs less than or equal to the length constraint.

### BRIEF SUMMARY

Aspects of the disclosure are directed to controlling machine translation length based on length tokens. The length tokens are included in the machine translation source text and target text during training such that a machine learning model can learn the length of each token. Length tokens are also included in the machine translation source text during inference such that the machine learning model can output a translation limited by length. If an output from a machine learning model unconstrained by length outputs a translation that exceeds a length limit, then a subsequent output is generated from a machine learning model constrained by length. If the subsequent output still exceeds the length limit, then another output is generated from the machine learning model constrained by length with a decreased length limit. Controlling machine translation length can be implemented in headlines and/or description in advertisements, user interface messages on mobile or other computing devices, or dubbing translations for movies or television. Aspects of the disclosure may therefore provide improved machine translation, in particular in implementations in which there are limitations imposed on the field or context in which translated text is stored, output, or displayed. By controlling machine translation length as described herein, information that may be lost, for instance if a translated text was to exceed a length limit, is instead retained and can be stored, communicated, or displayed to a user.

An aspect of the disclosure provides for a method for length-constrained machine translation. The method includes: receiving, by one or more processors, data corresponding to a source text; translating, by the one or more processors, the source text using a machine learning model unconstrained by length to generate data corresponding to a first translated text; determining, by the one or more processors, the first translated text exceeds a length limit; translating, by the one or more processors, the source text using a machine learning model constrained by length to generate data corresponding to a second translated text; and outputting, by the one or more processors, the data corresponding to the second translated text.

In an example, the method further includes determining, by the one or more processors, the second translated text exceeds the text length limit; and decreasing, by the one or more processors, a length limit for the machine learning model constrained by length; where the length limit for the machine learning model constrained by length is iteratively decreased until a translated text translated using the machine learning model constrained by length does not exceed the length limit.

In another example, the method further includes adding, by the one or more processors, a length token to a beginning of the source text to represent the length limit. In yet another example, the method further includes estimating, by the one or more processors, a length of the first translated text. In yet another example, the method further includes increasing, with the one or more processors, a randomness value of the length limit.

In yet another example, the method further includes training, with the one or more processors, the machine learning model constrained by length using training data including a plurality of pairs of source text and translated text, each added with one or more length tokens. In yet another example, the source text of each pair includes a length token added to a beginning of the source text to represent the text length limit. In yet another example, the translated text of each pair includes one or more length tokens added after each tokenized text element to represent a remainder of the text length limit. In yet another example, the method further includes merging, with the one or more processors, the training data with training data for the machine learning model unconstrained by length.

Another aspect of the disclosure provides for a system including: one or more processors; and one or more storage devices coupled to the one or more processors and storing instructions that, when executed by the one or more processors, cause the one or more processors to perform operations for length-constrained machine translation. The operations include: receiving data corresponding to a source text; translating the source text using a machine learning model unconstrained by length to generate data corresponding to a first translated text; determining the first translated text exceeds a length limit; translating the source text using a machine learning model constrained by length to generate data corresponding to a second translated text; and outputting the data corresponding to the second translated text.

In an example, the operations further include determining the second translated text exceeds the text length limit; and decreasing a length limit for the machine learning model constrained by length; where the length limit for the machine learning model constrained by length is iteratively decreased until a translated text translated using the machine learning model constrained by length does not exceed the length limit.

In another example, the operations further include adding a length token to a beginning of the source text to represent the length limit. In yet another example, the operations further include estimating a length of the first translated text. In yet another example, the operations further include increasing a randomness value of the length limit.

In yet another example, the operations further include training the machine learning model constrained by length using training data including a plurality of pairs of source text and translated text, each added with one or more length tokens. In yet another example, the source text of each pair includes a length token added to a beginning of the source text to represent the text length limit. In yet another example, the translated text of each pair includes one or more length tokens added after each tokenized text element to represent a remainder of the text length limit. In yet another example, the operations further include merging the training data with training data for the machine learning model unconstrained by length.

Yet another aspect of the disclosure provides for a non-transitory computer readable medium for storing instructions that, when executed by one or more processors, cause the one or more processors to perform operations for length-constrained machine translation. The operations include: receiving data corresponding to a source text; translating the source text using a machine learning model unconstrained by length to generate data corresponding to a first translated text; determining the first translated text exceeds a length limit; translating the source text using a machine learning model constrained by length to generate data corresponding to a second translated text; and outputting the data corresponding to the second translated text.

In an example, the operations further include: determining the second translated text exceeds the text length limit; and decreasing a length limit for the machine learning model constrained by length; where the length limit for the machine learning model constrained by length is iteratively decreased until a translated text translated using the machine learning model constrained by length does not exceed the length limit.

In another example, the operations further include adding a length token to a beginning of the source text to represent the length limit. In yet another example, the operations further include estimating a length of the first translated text. In yet another example, the operations further include increasing a randomness value of the length limit.

In yet another example, the operations further include training the machine learning model constrained by length using training data including a plurality of pairs of source text and translated text, each added with one or more length tokens. In yet another example, the source text of each pair includes a length token added to a beginning of the source text to represent the text length limit. In yet another example, the translated text of each pair includes one or more length tokens added after each tokenized text element to represent a remainder of the text length limit. In yet another example, the operations further include merging the training data with training data for the machine learning model unconstrained by length.

### BRIEF DESCRIPTION OF THE DRAWINGS

FIG. 1 depicts a block diagram of an example length constrained machine translation system according to aspects of the disclosure.

FIG. 2 depicts a block diagram of an example environment for implementing a length constrained machine translation system according to aspects of the disclosure.

FIG. 3 depicts a block diagram of example machine translation model architectures according to aspects of the disclosure.

FIG. 4 depicts a flow diagram of an example process for training machine translation models according to aspects of the disclosure.

FIG. 5 depicts a flow diagram of an example process for length constrained machine translation according to aspects of the disclosure.

FIG. 6 depicts a block diagram of an example length constrained machine translation system where the unconstrained and constrained machine learning models can be unified according to aspects of the disclosure.

### DETAILED DESCRIPTION

Generally disclosed herein are implementations for controlling machine translation length based on length tokens. The length tokens are added in the machine translation source text and target text during training such that a machine learning model can learn the length of each token. The source text can correspond to text to be translated. In the source text, a length token is inserted at the beginning of the text to indicate the required length constraint. The target text can correspond to a translation of the source text. In the target text, one or more length tokens are inserted within the translated text to indicate the remainder of the length constraint. Controlling machine translation length can be implemented in headlines and/or description in advertisements, user interface messages on mobile or other computing devices, or dubbing translations.

For training the machine learning model, training data can contain source-translation pairs as well as other metadata such as timestamp, component type, product, etc. A sentence piece model (SPM), which can contain a mapping from tokens to identifiers, can be trained using the training data. Based on outputs from the SPM model, the source-translation pairs in the training data can be tokenized and converted to identifiers to generate tokenized training data. The machine learning model can be trained using the tokenized training data.

To control a length of the machine translation, length tokens can be inserted into the source text and target text such that the machine learning model is aware of the length information. To train the machine learning model to consider length, the training data can further contain a length constraint.

The length constraint can correspond to an actual length constraint or a pseudo length constraint. The actual length constraint can correspond to a predetermined length limit included with the training data. The pseudo length constraint can correspond to the length limit being the length of the translation text when the training data does not include an actual length constraint. The length constraint can be represented numerically and can limit the number of characters, words, or phrases, as examples.

Length tokens can be added to the source text and target text to represent the length constraint. A length token can be added at the beginning of the source text. One or more length tokens can also be added after each tokenized text element of the target text, such as after each word token, to indicate a remainder of the length constraint. For example, the remainder can be represented numerically to indicate the number of remaining characters, words, or phrases that can be generated.

The length constraint can further include a randomness value during model training, since forcing the machine learning model to output exactly the same length, as opposed to a length between ranges, may not maintain translation quality with such a restrictive constraint. Adding a randomness value provides the machine learning model some flexibility in generating a translation length. The length-flexibility can be represented by a hyperparameter.

For model inference, the model can tokenize the source text and then convert into source identifiers. The source identifiers can be input into the trained machine learning model, which after encoding and decoding, can output target identifiers. The target identifiers can be converted and detokenized to a machine translation.

To control a length of the machine translation, the model inference is similar to the training. For instance, length tokens can be added at the beginning of the source text. Where the model inference differs is in generating a length-constrained machine translation output using a hybrid approach described below and iteratively retrying the model inference with a decreasing length limit.

Given a length constraint, the machine learning model should produce a translation whose length is less than or equal to the length constraint. The hybrid approach accounts for this, where a translation is generated by a machine learning model unconstrained by length and, if the translation exceeds the length limit, the translation is generated again by the length-constrained machine learning model. Further, to increase accuracy, if the translation still exceeds the length limit with the length-constrained machine learning model, then the length limit is decreased and the length-constrained machine learning model is run again. Decreasing the length limit is repeated until the translation is length compliant.

The process for length-constrained machine translation inference can include some variations to unify the unconstrained and constrained models to decrease complexity. For example, a target length for the machine translation can be estimated before running model inference. The target length can be estimated by rule or by model. As another example, the length flexibility can be increased to a value greater than the length limit. To mitigate sparsity issues, the training data can include a number of randomly generated examples in addition to actual examples. As yet another example, the distribution of the length flexibility can be changed. As yet another example, the training data of the unconstrained model and the length-constrained model can be merged. Here, the machine learning model can learn that, if the first token is not a length token, the unconstrained translation can be output, but if the first token is a length token, the constrained translation can be output.

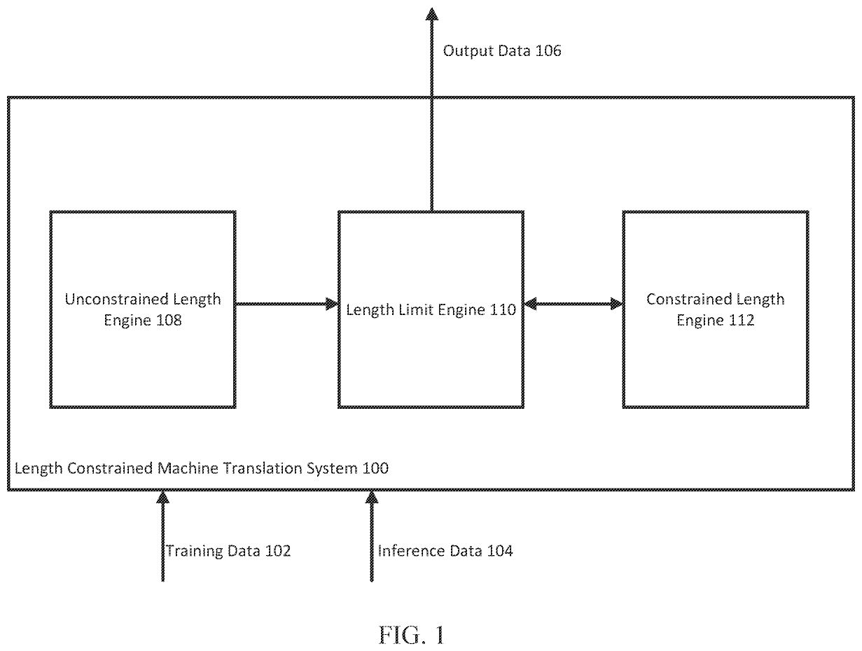

FIG. 1 depicts a block diagram of an example length constrained machine translation system 100. The length constrained machine translation system 100 can be configured to receive input data, including training data 102 and inference data 104, via a user interface. For example, the length constrained machine translation system 100 can receive the input data as part of a call to an API exposing the length constrained machine translation system 100. The length constrained machine translation system 100 can be implemented on one or more computing devices. Input to the length constrained machine translation system 100 can also be provided through a storage medium, including remote storage connected to the one or more computing devices over a network, or as input through a user interface on a client computing device coupled to the length constrained machine translation system 100.

The length constrained machine translation system 100 can be configured to receive the training data 102 for training a machine learning model in translation and inference data 104 specifying target translations. The training data 102 can correspond to a machine learning task related to translation, such as a neural network task performed by a neural network. The training data 102 can be split into a training set, a validation set, and/or a testing set. An example training/testing split can be an 80/20 split. The machine learning model can be configured to receive any type of input data to generate output data 106 for performing the machine learning task related to translation. As examples, the output data 106 can be any kind of score, classification, or regression output translating the input data. Correspondingly, the machine learning task can be a scoring, classification, and/or regression task related to translation. These machine learning tasks can correspond to a variety of different applications in processing images, video, text, speech, or other types of data for translation.

The training data 102 can be in any form suitable for training a machine learning model, according to one of a variety of different learning techniques. Learning techniques for training a machine learning model can include supervised learning, unsupervised learning, and semi-supervised learning techniques. For example, the training data 102 can include multiple training examples that can be received as input by a machine learning model. The training examples can be labeled with a desired output for the machine learning model when processing the labeled training examples. The label and the model output can be evaluated through a loss function to determine an error, which can be backpropagated through the machine learning model to update weights for the machine learning model. For example, if the machine learning task is a classification task, the training examples can be images labeled with one or more classes categorizing subjects depicted in the images. As another example, a supervised learning technique can be applied to calculate an error between outputs, with a ground-truth label of a training example processed by the machine learning model. Any of a variety of loss or error functions appropriate for the type of the task the machine learning model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The machine learning model can be trained until stopping criteria are met, such as a number of iterations for training, a maximum period of time, a convergence, or when a minimum accuracy threshold is met.

The training data 102 can include source-translation pairs in addition to metadata, such as timestamp, component type, product, etc. The source-translation pairs can be tokenized and converted to identifiers to generate tokenized training data based on a mapping. The mapping can be determined by a sentence piece model (SPM) as an example. A machine learning model can be trained for translation using the tokenized training data.

For example, a source text of a source-translation pair can be “cheap rental cars Miami”. The source text can be tokenized into [“_cheap”, “_rental”, “_cars”, “_Mi”, “ami”, “</s>] and then converted to a list of identifiers [8174, 6509, 6984, 602, 5943, 2]. “_” can represent a word boundary, “<s>” can indicate the beginning of a sentence in source text, and “</s>” can indicate the end of a sentence in a target text of the source-translation pair. Infrequent words, such as “Miami,” can be split up into subwords.

The training data 102 can include a length constraint for training a machine learning model to consider length when translating. For example, the source-translation pairs can be formatted as follows: (source, length_constraint)->translation. The length constraint can correspond to an actual length constraint, such as a predetermined length limit included with the training data 102, or a pseudo length constraint, such as the length of the target text in the source-translation pair. The length constraint can be represented numerically and can limit the number of characters, words, or phrases, as examples. For example, for training data 102 including the source-translation pair: “Nice to meet you!”->“ [symbol] ”, the pseudo length constraint can be 7, indicated by the 6 Chinese characters and 1 exclamation mark. Here, the source-translation pair can be formatted as (“Nice to meet you!”, 7)->“ [symbol] ”. In another example, for training data 102 including the source-translation pair: “Hello”->“ [symbol] [symbol] ”, the pseudo length constraint can be 2, indicated by the 2 Chinese characters. Here, the source-translation pair can be formatted as (“Hello”, 2)->“ [symbol] ”.

The source-translation pairs of the training data 102 can include length tokens in source text and target text to represent the length constraint. For example, the length token can be represented as “TOKxx”, where “xx” is the length constraint. The source text can include the length token before its text to be translated. The target text can include one or more length tokens after each tokenized text element of the translated text, indicating a remainder of the length constraint. As an example, the remainder can be represented numerically to indicate the number of remaining characters, words, or phrases that can be generated.

The following is an example source-translation pair of training data 102 for a machine learning model for translating from English to Spanish when the pseudo length constraint is 49:

Source_word: [“<TOK49>”, “_He”, “_looks”, “_around”, “,”, “_seemingly”, “_un”, “sure”,
“_of”, “_where”, “_he”, “_is”, “.”, “</s>”].
Target_word: [“<s>”, “_Mira”, “<TOK45>”, “_alrededor”, “<TOK35>”, “_como”,
“<TOK30>”, “_si”, “TOK27>”, “_no”, “<TOK24>”, “_sup”, “<TOK20>”, “iera”,
“<TOK16>”, “_donde”, “<TOK10>”, “_se”, “<TOK7>”, “_halla”, “<TOK1>”, “.”,
“<TOK0>”].

Since the pseudo length constraint is 49, a length token “<TOK49>” is inserted into the source text. In the target text, <TOKxx> represents the number of remaining characters that can be generated. Therefore, after output “_Mira”, the remaining characters decrease to 45, and after output “_alrededor”, the remaining characters further decrease to 35. This repeats until all tokens have been output. Since the pseudo length constraint is equal to the length of the target text, the last token in the target_word should be “<TOK0>”, indicating no characters remain.

The length constraint in the training data 102 can further include a randomness value, since forcing the machine learning model to output exactly the same length, as opposed to a length between ranges, may not maintain translation quality with such a restrictive constraint. Adding a randomness value provides the machine learning model some flexibility in generating a translation length.

For example, the length constraint can be represented as follows: length_constraint=len(target)+uniform_random(0,R), where R is a hyperparameter representing the length-flexibility of the machine learning model. For example, if the length constraint is 50 characters and R is 10, then the machine learning model can output translation lengths between 40 and 50 characters. Increasing R allows the machine learning model to generate a wider range of translation length, but also increases sparsity of the training data 102, which can increase the difficulty of machine learning model learning the length constraint.

The inference data 104 can correspond to data to be translated based on a machine learning model trained with the training data 102. The inference data 104 can include a source text as well as other metadata, such as timestamp, component type, product, etc. The source text of the inference data 104 can include a length token at the beginning of the text to be translated. For example, the length token can be represented as “TOKxx”, where “xx” represents the length constraint.

The source text can be tokenized and converted to identifiers to generate tokenized inference data based on a mapping. The mapping can be determined by a SPM as an example. The tokenized inference data can be input into the trained machine learning model to output target identifiers. The target identifiers can be converted and detokenized to a machine translation. The output data 106 can correspond to the machine translation. The output data can also correspond to the target identifiers, to be converted to the machine translation by another computing device. The length-constrained machine translation can be performed using a hybrid approach, including an unconstrained machine learning and a length constrained machine learning model, as well as iteratively retrying model inference with a decreasing length limit.

From the training data 102 and inference data 104, the length constrained machine translation system 100 can be configured to output one or more results of a machine learning task related to translation, generated as the output data 106. The output data 106 can be sent for display on a user display, as an example. In some implementations, the length constrained machine translation system 100 can be configured to provide the output data 106 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model.

The length constrained machine translation system 100 can be configured to forward the output data 106 to one or more other devices configured for converting the output data 106 into an executable program written in a computer programming language. The length constrained machine translation system 100 can also be configured to send the output data 106 to a storage device for storage and later retrieval.

The length constrained machine translation system 100 can include an unconstrained length engine 108. The unconstrained length engine 108 can be implemented as one or more computer programs, specially configured electronic circuitry, or any combination of the preceding. The unconstrained length engine 108 can be configured to generate a machine translation from the training data 102 and/or inference data 104 using a machine learning model unconstrained by length.

The length constrained machine translation system 100 can further include a length limit engine 110. The length limit engine 110 can be implemented as one or more computer programs, specially configured electronic circuitry, or any combination of the preceding. The length limit engine 110 can be configured to determine whether the machine translation generated by the unconstrained length engine 108 exceeds a length limit. The length limit engine 110 can compare the length of the machine translation output from the machine learning model unconstrained by length to a predetermined length limit. If the machine translation is less than or equal to the predetermined length limit, the machine translation can be output as the output data 106. If the machine translation is greater than the predetermined length limit, the machine translation is not output.

The length constrained machine translation system 100 can also include a constrained length engine 112. The constrained length engine 112 can be implemented as one or more computer programs, specially configured electronic circuitry, or any combination of the preceding. The constrained length engine 112 can be configured to generate a machine translation from the training data 102 and/or inference data 104 using a machine learning model constrained by the length limit. If the machine translation generated by the unconstrained length engine 108 exceeds a length limit, then the machine translation is generated again by the constrained length engine 112.

The length limit engine 110 can also be configured to determine whether the machine translation generated by the constrained length engine 112 exceeds the length limit. The length limit engine 110 can compare the length of the machine translation output from the machine learning model constrained by length to the predetermined length limit. If the machine translation is less than or equal to the predetermined length limit, the machine translation can be output as the output data 106.

If the machine translation is greater than the predetermined length limit, the machine translation is not output. Instead, the length limit engine 110 can decrease the length limit for the machine learning model constrained by length, such as by 1 character, word, or phrase. The constrained length engine 112 can generate a subsequent machine translation from the training data 102 and/or inference data 104 using the machine learning model constrained by the decreased length limit. The length limit engine 110 can determine whether the subsequent machine translation exceeds the original length limit. The length limit engine 110 can iteratively decrease the length limit for the machine learning model constrained by length and the constrained length engine 112 can iteratively generate a machine translation based on the iteratively decreasing length limit until the generated machine translation complies with the length limit, such as by being less or equal to the original length limit.

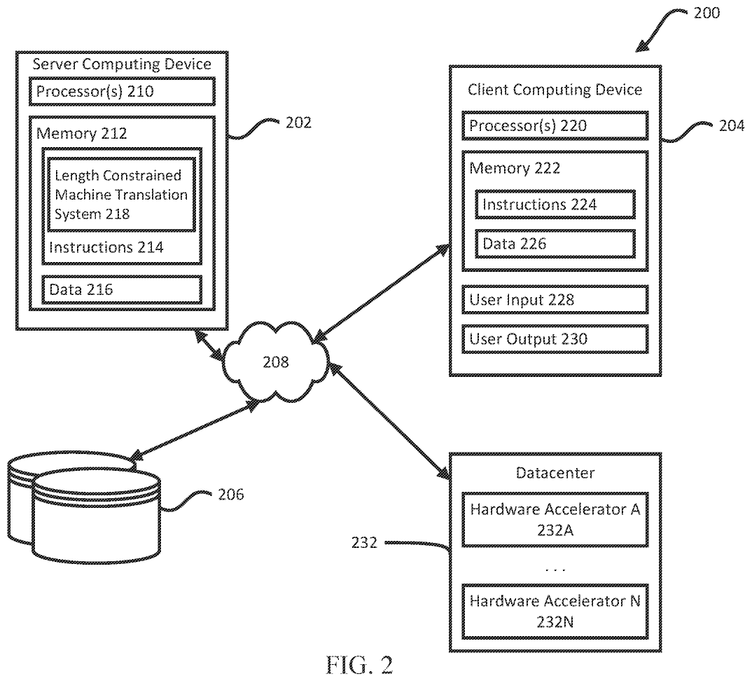

FIG. 2 depicts a block diagram of an example environment 200 for implementing a length constrained machine translation system. The system 200 can be implemented on one or more devices having one or more processors in one or more locations, such as in server computing device 202. Client computing device 204 and the server computing device 202 can be communicatively coupled to one or more storage devices 206 over a network 208. The storage devices 206 can be a combination of volatile and non-volatile memory and can be at the same or different physical locations than the computing devices 202, 204. For example, the storage devices 206 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 202 can include one or more processors 210 and memory 212. The memory 212 can store information accessible by the processors 210, including instructions 214 that can be executed by the processors 210. The memory 212 can also include data 216 that can be retrieved, manipulated, or stored by the processors 210. The memory 212 can be a type of non-transitory computer readable medium capable of storing information accessible by the processors 210, such as volatile and non-volatile memory. The processors 210 can include one or more central processing units (CPUs), graphic processing units (GPUs), field-programmable gate arrays (FPGAs), and/or application-specific integrated circuits (ASICs), such as tensor processing units (TPUs).

The instructions 214 can include one or more instructions that, when executed by the processors 210, cause the one or more processors to perform actions defined by the instructions 214. The instructions 214 can be stored in object code format for direct processing by the processors 210, or in other formats including interpretable scripts or collections of independent source code modules that are interpreted on demand or compiled in advance. The instructions 214 can include instructions for implementing a length constrained machine translation system 218, which can correspond to the length constrained machine translation system 100 of FIG. 1. The length constrained machine translation system 218 can be executed using the processors 210, and/or using other processors remotely located from the server computing device 202.

The data 216 can be retrieved, stored, or modified by the processors 210 in accordance with the instructions 214. The data 216 can be stored in computer registers, in a relational or non-relational database as a table having a plurality of different fields and records, or as JSON, YAML, proto, or XML documents. The data 216 can also be formatted in a computer-readable format such as, but not limited to, binary values, ASCII, or Unicode. Moreover, the data 216 can include information sufficient to identify relevant information, such as numbers, descriptive text, proprietary codes, pointers, references to data stored in other memories, including other network locations, or information that is used by a function to calculate relevant data.

The client computing device 204 can also be configured similarly to the server computing device 202, with one or more processors 220, memory 222, instructions 224, and data 226. The client computing device 204 can also include a user input 228 and a user output 230. The user input 228 can include any appropriate mechanism or technique for receiving input from a user, such as keyboard, mouse, mechanical actuators, soft actuators, touchscreens, microphones, and sensors.

The server computing device 202 can be configured to transmit data to the client computing device 204, and the client computing device 204 can be configured to display at least a portion of the received data on a display implemented as part of the user output 230. The user output 230 can also be used for displaying an interface between the client computing device 204 and the server computing device 202. The user output 230 can alternatively or additionally include one or more speakers, transducers or other audio outputs, a haptic interface or other tactile feedback that provides non-visual and non-audible information to the platform user of the client computing device 204.

Although FIG. 2 illustrates the processors 210, 220 and the memories 212, 222 as being within the computing devices 202, 204, components described herein can include multiple processors and memories that can operate in different physical locations and not within the same computing device. For example, some of the instructions 214, 224 and the data 216, 226 can be stored on a removable SD card and others within a read-only computer chip. Some or all of the instructions and data can be stored in a location physically remote from, yet still accessible by, the processors 210, 220. Similarly, the processors 210, 220 can include a collection of processors that can perform concurrent and/or sequential operation. The computing devices 202, 204 can each include one or more internal clocks providing timing information, which can be used for time measurement for operations and programs run by the computing devices 202, 204.

The server computing device 202 can be connected over the network 208 to a datacenter 232 housing any number of hardware accelerators 232A-N. The datacenter 232 can be one of multiple datacenters or other facilities in which various types of computing devices, such as hardware accelerators, are located. Computing resources housed in the datacenter 232 can be specified for deploying machine learning models for translation as described herein.

The server computing device 202 can be configured to receive requests to process data from the client computing device 204 on computing resources in the datacenter 232. For example, the environment 200 can be part of a computing platform configured to provide a variety of services to users, through various user interfaces and/or application programming interfaces (APIs) exposing the platform services. The variety of services can include generating one or more machine learning models for translation. The client computing device 204 can transmit data specifying text to be translated along with a length limit for the translated text. The length constrained machine translation system 218 can receive the data specifying the text to be translated and the length limit, and in response, generate output data including a translated text compliant with the length limit.

As other examples of potential services provided by a platform implementing the environment 200, the server computing device 202 can maintain a variety of machine learning models in accordance with different potential length limits or translation specifics available at the datacenter 232. For example, the server computing device 202 can maintain different families for deploying neural networks on the various types of TPUs and/or GPUs housed in the datacenter 232 or otherwise available for processing.

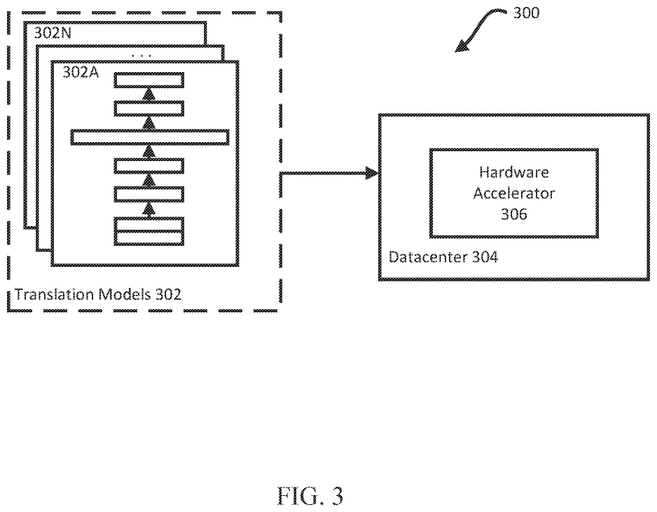

FIG. 3 depicts a block diagram 300 illustrating one or more machine translation model architectures 302, more specifically 302A-N for each architecture, for deployment in a datacenter 304 housing a hardware accelerator 306 on which the deployed machine translation models 302 will execute for providing translations constrained by a length limit. The hardware accelerator 306 can be any type of processor, such as a CPU, GPU, FPGA, or ASIC such as a TPU.

An architecture 302 of a machine translation model can refer to characteristics defining the model, such as characteristics of layers for the model, how the layers process input, or how the layers interact with one another. The machine translation model architectures 302 can be for machine learning models unconstrained by length or machine learning models constrained by length. The machine translation model architectures 302 can correspond to encoder-decoder architectures, such as transformers. Input data, such as input text, can be parsed into tokens, such as by a byte pair encoding tokenizer. Each token can be converted into a vector, such as via word embedding.

The encoder can include encoding layers that process input data iteratively layer by layer while the decoder includes decoding layers that process output data of the encoder iteratively layer by layer. Each encoder layer can generate encodings that contain information about which parts of the input data are relevant to each other. Each encoder layer then sends its encodings to the next encoder layer as inputs. Each decoder layer can consider all the encodings and use their contextual information to generate an output sequence. For each part of the input, attention units, such as scaled dot-product attention units, can weigh the relevance of each other part and produce an output from them. Each decoder layer can have additional attention mechanisms to draw information from outputs of previous decoders, before the decoder layer draws information from the encodings. Both encoder and decoder layers can include a feed-forward neural network for additional processing of outputs as well as contain residual connections and layer normalization steps.

One or more machine translation model architectures 302 can be generated that can output translation results compliant with a length limit.

Referring back to FIG. 2, the devices 202, 204 and the datacenter 232 can be capable of direct and indirect communication over the network 208. For example, using a network socket, the client computing device 204 can connect to a service operating in the datacenter 232 through an Internet protocol. The devices 202, 204 can set up listening sockets that may accept an initiating connection for sending and receiving information. The network 208 itself can include various configurations and protocols including the Internet, World Wide Web, intranets, virtual private networks, wide area networks, local networks, and private networks using communication protocols proprietary to one or more companies. The network 208 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 208, in addition or alternatively, can also support wired connections between the devices 202, 204 and the datacenter 232, including over various types of Ethernet connection.

Although a single server computing device 202, client computing device 204, and datacenter 232 are shown in FIG. 2, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing machine learning models, and any combination thereof.

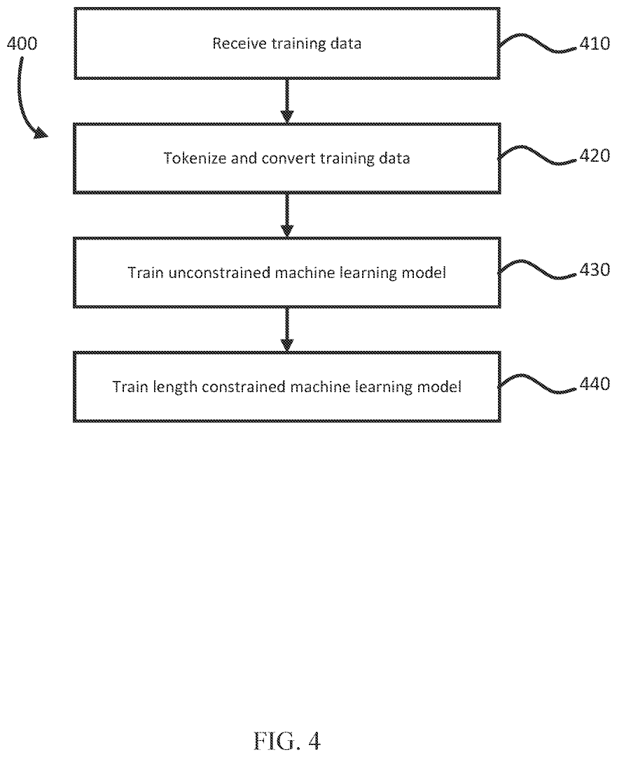

FIG. 4 depicts a flow diagram of an example process 400 for training the machine translation models. The example process 400 can be performed on a system of one or more processors in one or more locations, such as the length constrained machine translation system 100 of FIG. 1.

As shown in block 410, the unconstrained length engine 108 and/or the constrained length engine 112 can receive training data 102. The training data 102 can include source-translation pairs. The training data 102 for the unconstrained length engine 108 may not include a length constraint while the training data 102 for the constrained length engine 112 can include a length constraint. The length constraint can correspond to an actual length constraint or a pseudo length constraint. The length constraint can further include a randomness value to add flexibility to the machine translation length.

As shown in block 420, the unconstrained length engine 108 and/or the constrained length engine 112 can tokenize and convert the training data 102. The unconstrained length engine 108 can convert the training data 102 to identifiers based on a mapping, which can be determined by a SPM. The constrained length engine 112 can tokenize the training data 102 by inserting length tokens in source text and target text of the source-translation pairs to represent the length constraint. The source text can include a length token before its text to be translated. The target text can include one or more length tokens after each tokenized text element of the translated text, indicating a remainder of the length constraint. The constrained length engine 112 can then convert the tokenized training data 102 to identifiers based on a mapping, which can be determined by a SPM.

As shown in block 430, the unconstrained length engine 108 can train an unconstrained machine learning model for translation based on the training data 102 converted to identifiers. The unconstrained length engine 108 can train the unconstrained machine learning model using various learning techniques, including supervised learning, unsupervised learning, or semi-supervised learning. The unconstrained machine learning model can correspond to a transformer having an encoder-decoder architecture.

As shown in block 440, the constrained length engine 112 can train a length constrained machine learning model for translation based on the training data 102 tokenized and converted to identifiers. The constrained length engine 112 can train the length constrained machine learning model using various learning techniques, including supervised learning, unsupervised learning, or semi-supervised learning. The constrained machine learning model can correspond to a transformer having an encoder-decoder architecture.

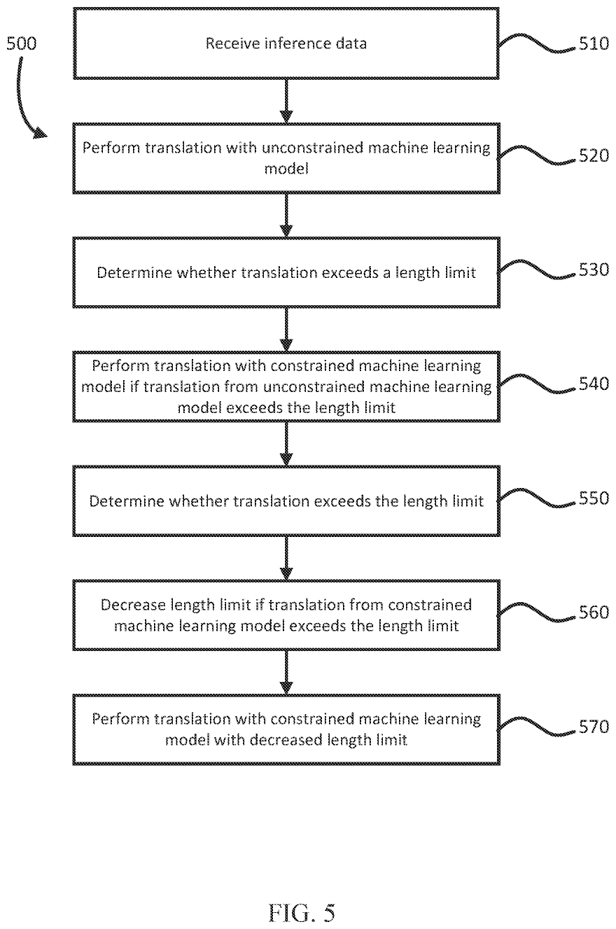

FIG. 5 depicts a flow diagram of an example process 500 for length constrained machine translation. The example process 500 can be performed on a system of one or more processors in one or more locations, such as the length constrained machine translation system 100 of FIG. 1.

As shown in block 510, the unconstrained length engine 108 can receive inference data 104. The inference data 104 can include a source text with a length token at the beginning of the text to be translated to represent a length constraint.

As shown in block 520, the unconstrained length engine 108 can perform a machine translation using an unconstrained machine learning model to generate a translation.

As shown in block 530, the length limit engine 110 can determine whether the translation from the unconstrained machine learning model exceeds a length limit. The length limit engine 110 can compare the length of the translation from the unconstrained machine learning model with the length limit. If the translation is less than or equal to the length limit, the translation can be output.

If the translation is greater than the length limit, as shown in block 540, the constrained length engine 112 can perform a machine translation using a constrained machine learning model to generate another translation. The constrained machine learning model can output additional length tokens in its output translation compared to the unconstrained machine learning model output. If additional length tokens are output, the additional length tokens can be removed with post-processing.

As shown in block 550, the length limit engine 110 can determine whether the translation from the constrained machine learning model exceeds the length limit. The length limit engine 110 can compare the length of the translation from the constrained machine learning model with the length limit. If the translation is less than or equal to the length limit, the translation can be output.

If the translation is greater than the length limit, as shown in block 560, the length limit engine 110 can decrease the length limit. For example, the length limit engine 110 can decrease the length limit by 1 character, word, or phrase.

As shown in block 570, the constrained length engine 112 can perform a subsequent machine translation using the constrained machine learning model with the decreased length limit to generate another translation. The length limit engine 110 can determine whether the subsequent translation from the constrained machine learning model exceeds the original length limit. If the translation is less than or equal to the original length limit, the translation can be output. If the translation is greater than the original length limit, the length limit engine 110 can decrease the length limit again, such as by 1 character, word, or phrase. The length limit engine 110 and the constrained length engine 112 can iteratively decrease the length limit and perform a machine translation using a constrained machine learning model until the translation complies with the original length limit.

The general process for length-constrained machine translation inference can be further described as follows:

```
  Input: source text source, length limit L, unconstrained MT model m1, length-
constrained MT model m2, maximum try times max_retry_count.
  Output: length constrained MT output.
  mt = runInference(m1, source)
  current_limit = L
  while len(mt) > L and max_retry_count >= 0:
  mt = runInference(m2, source, current_limit)
  current_limit = current_limit − 1
  max_retry_count = max_retry_count − 1
  return mt
```

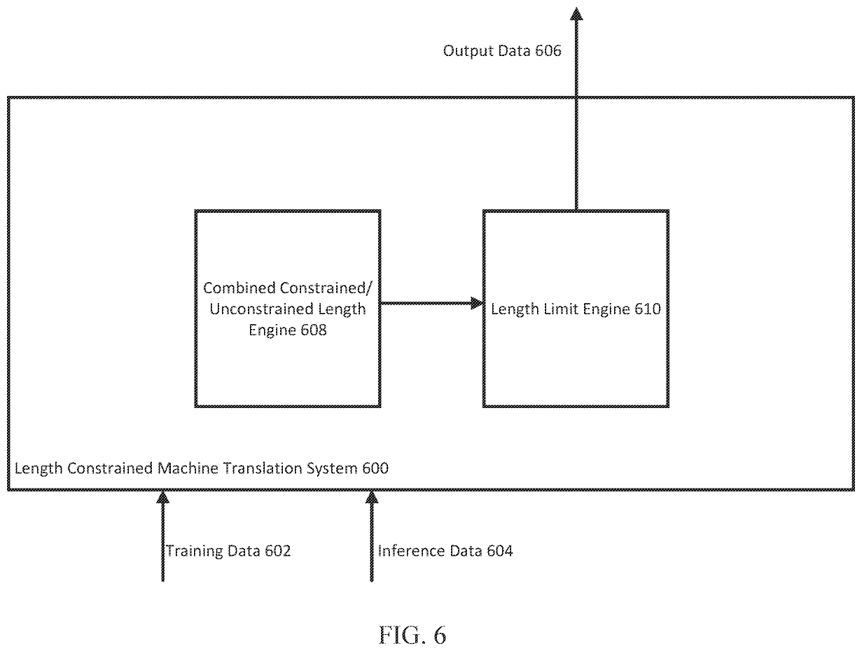

FIG. 6 depicts a block diagram of an example length constrained machine translation system 600 where the unconstrained and constrained machine learning models can be unified to decrease complexity. The training data 602, inference data 604, and output data 606 can correspond to the training data 102, inference data 104, and output data 106 of FIG. 1.

The length constrained machine translation system 600 can include combined constrained/unconstrained length engine 608. The combined length engine 608 can be implemented as one or more computer programs, specially configured electronic circuitry, or any combination of the preceding. The combined length engine 608 can be configured to train a machine learning model for length constrained translation and perform length constrained translation using the trained machine learning model.

The length constrained machine translation system 600 can further include a length limit engine 610. The length limit engine 610 can be implemented as one or more computer programs, specially configured electronic circuitry, or any combination of the preceding.

For example, the length limit engine 610 can be configured to estimate a target length for the machine translation before running model inference with combined length engine 608. The length limit engine 610 can estimate the target length by rule or by model. For rule-based estimation, the length limit engine 610 can estimate the target length by multiplying the length of the source text by a predetermined factor, as an example. For model-based estimation, the length limit engine 610 can estimate the target length by running a machine learning model for length estimation.

As another example, the length limit engine 610 can increase the length flexibility to a value greater than a length limit. To mitigate sparsity issues, the training data 602 can include a number of randomly generated examples in addition to actual examples.

As yet another example, the combine length engine 608 can change the distribution of the length flexibility. Here, the training data 602 can be generated using a lower length flexibility value and a higher length flexibility value. The combine length engine 608 can merge the two training datasets.

As yet another example, the combined length engine 608 can merge the training data 602 of the unconstrained model and the length-constrained model. Here, the machine learning model can learn that, if the first token is not a length token, the unconstrained translation can be output as the output data 606, but if the first token is a length token, the constrained translation can be output as the output data 606.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

The phrase “configured to” is used in different contexts related to computer systems, hardware, or part of a computer program. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for length-constrained machine translation, comprising:
receiving, by one or more processors, data corresponding to a source text;
translating, by the one or more processors, the source text using a machine learning model unconstrained by length to generate data corresponding to a first translated text;
determining, by the one or more processors, the first translated text exceeds a length limit;
translating, by the one or more processors, the source text using a machine learning model constrained by length to generate data corresponding to a second translated text; and
outputting, by the one or more processors, the data corresponding to the second translated text.

2. The method of claim 1, further comprising:
determining, by the one or more processors, the second translated text exceeds the text length limit; and
decreasing, by the one or more processors, a length limit for the machine learning model constrained by length;
wherein the length limit for the machine learning model constrained by length is iteratively decreased until a translated text translated using the machine learning model constrained by length does not exceed the length limit.

3. The method of claim 1, further comprising adding, by the one or more processors, a length token to a beginning of the source text to represent the length limit.

4. The method of claim 1, further comprising estimating, by the one or more processors, a length of the first translated text.

5. The method of claim 1, further comprising increasing, with the one or more processors, a randomness value of the length limit.

6. The method of claim 1, further comprising training, with the one or more processors, the machine learning model constrained by length using training data comprising a plurality of pairs of source text and translated text, each added with one or more length tokens.

7. The method of claim 6, wherein the source text of each pair comprises a length token added to a beginning of the source text to represent the text length limit.

8. The method of claim 6, wherein the translated text of each pair comprises one or more length tokens added after each tokenized text element to represent a remainder of the text length limit.

9. The method of claim 6, further comprising merging, with the one or more processors, the training data with training data for the machine learning model unconstrained by length.

10. A system comprising:
one or more processors; and
one or more storage devices coupled to the one or more processors and storing instructions that, when executed by the one or more processors, cause the one or more processors to perform operations for length-constrained machine translation, the operations comprising:
receiving data corresponding to a source text;
translating the source text using a machine learning model unconstrained by length to generate data corresponding to a first translated text;
determining the first translated text exceeds a length limit;
translating the source text using a machine learning model constrained by length to generate data corresponding to a second translated text; and
outputting the data corresponding to the second translated text.

11. The system of claim 10, wherein the operations further comprise:
determining the second translated text exceeds the text length limit; and
decreasing a length limit for the machine learning model constrained by length;
wherein the length limit for the machine learning model constrained by length is iteratively decreased until a translated text translated using the machine learning model constrained by length does not exceed the length limit.

12. The system of claim 10, wherein the operations further comprise adding a length token to a beginning of the source text to represent the length limit.

13. The system of claim 10, wherein the operations further comprise estimating a length of the first translated text.

14. The system of claim 10, wherein the operations further comprise increasing a randomness value of the length limit.

15. The system of claim 10, wherein the operations further comprise training the machine learning model constrained by length using training data comprising a plurality of pairs of source text and translated text, each added with one or more length tokens.

16. The system of claim 15, wherein the source text of each pair comprises a length token added to a beginning of the source text to represent the text length limit.

17. The system of claim 15, wherein the translated text of each pair comprises one or more length tokens added after each tokenized text element to represent a remainder of the text length limit.

18. The system of claim 15, wherein the operations further comprise merging the training data with training data for the machine learning model unconstrained by length.

19. A non-transitory computer readable medium for storing instructions that, when executed by one or more processors, cause the one or more processors to perform operations for length-constrained machine translation, the operations comprising:
receiving data corresponding to a source text;
translating the source text using a machine learning model unconstrained by length to generate data corresponding to a first translated text;
determining the first translated text exceeds a length limit;
translating the source text using a machine learning model constrained by length to generate data corresponding to a second translated text; and
outputting the data corresponding to the second translated text.

20. The non-transitory computer readable medium of claim 19, wherein the operations further comprise:
determining the second translated text exceeds the text length limit; and
decreasing a length limit for the machine learning model constrained by length;
wherein the length limit for the machine learning model constrained by length is iteratively decreased until a translated text translated using the machine learning model constrained by length does not exceed the length limit.

21-27. (canceled)
